(19) United States
(12) Patent Application Publication
(10) Pub. No.: US 2012/0133588 A1
(43) Pub. Date: May 31, 2012

(54) KEYBOARD CAPABLE OF DISPLAYING TIME

(75) Inventors: PO-CHING HUANG, Tu-Cheng (TW); GUO-LIANG YEH, Tu-Cheng (TW); TZU-CHENG YU, Santa Clara, CA (US); CHIA-CHIA HUANG, Tu-Cheng (TW)

(73) Assignee: CHI MEI COMMUNICATION SYSTEMS, INC., Tu-Cheng (TW)

(21) Appl. No.: 13/170,167

(22) Filed: Jun. 27, 2011

(30) Foreign Application Priority Data
Nov. 26, 2010 (TW) 99140877

(51) Int. Cl. G06F 3/02

(52) U.S. Cl. 345/168

(57) ABSTRACT

A keyboard displays a clock time with light sources. The keyboard can transmit light through spaces positioned between a plurality of keys of the keyboard. The keyboard further can transmit light through the plurality of keys of the keyboard. The keyboard further includes two buttons for adjusting the clock time displaying on the keyboard.

### BACKGROUND

1. Technical Field

Embodiments of the present disclosure relate to device input, and more particularly to a keyboard for an electronic device.

2. Description of Related Art

While a typical used keyboard provides standardized input, some user convenience may be sacrificed. Such information as current time, for example, may be difficult to check from other sources if environmental light is low. What is needed, therefore, is a keyboard capable of overcoming the limitations described.

### BRIEF DESCRIPTION OF THE DRAWINGS

FIG. 1 is a schematic diagram of one embodiment of a keyboard.

FIG. 2 is a schematic diagram of one embodiment of the keyboard of FIG. 1 displaying a clock time using a seven segment display.

FIG. 3 is a schematic diagram of one embodiment of the keyboard of FIG. 1 displaying the clock time using a dot digital display.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

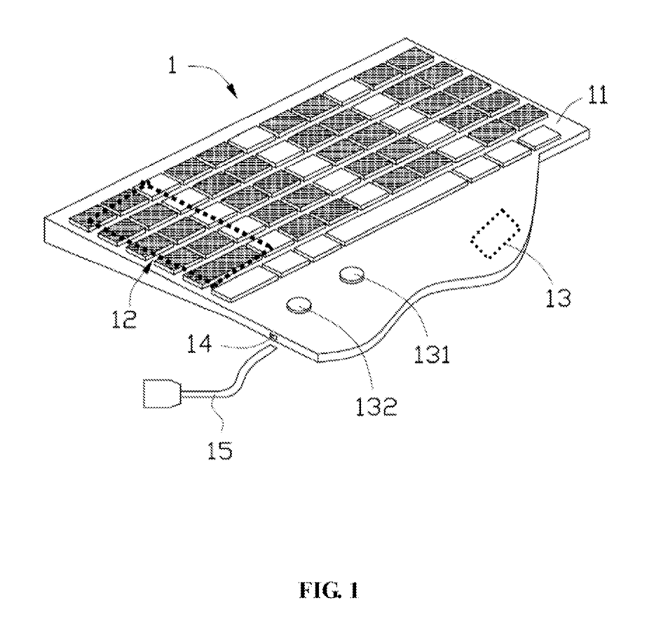

FIG. 1 is a schematic diagram of one embodiment of a keyboard 1. Depending on the embodiment, the keyboard 1 may be a computer keyboard or handheld computer keyboard. The keyboard 1 includes a keyboard housing 11, a plurality of keys 10, time display means 12, a real time controller 13, two buttons 131,132 and at least one USB interface 14.

The plurality of keys 10 are disposed in the keyboard housing 11. In one embodiment, the plurality of keys 10 may include 101 or 104 keys. The plurality of keys 10 are generally positioned in a middle region of the keyboard housing 11.

The time display means 12 is arranged below the plurality of keys 10 and positioned in the keyboard housing 11. As shown in FIG. 1, the time display means 12 is arranged below a the dark regions of the plurality of keys 10. The time display means 12 includes light sources (not shown).

In one embodiment, the time display means 12 may be a dot matrix digital display. The time display means 12 is positioned at bottom sides of the plurality of keys 10. In addition, the light sources of the time display means 12 are under the bottom sides of the plurality of keys 10. The light sources of the time display means 12 transmit light through materials of the plurality of keys 10. In one embodiment, the material of the plurality of keys 10 can be translucent, allowing passage of illumination there through.

In other embodiments, the time display means 12 may be a seven segment digital display. The time display means 12 are positioned at the bottom sides of the plurality of keys 10. The light sources of the seven segment digital displays are positioned spaces between the plurality of keys 10. Accordingly, the light sources of the time display means 12 can transmit light through the spaces.

The light sources are light-emitting diodes (LEDs), and can provide illumination in a variety of colors. For example, the colors may be a red, a blue or a green color. In other embodiments, the light sources are light emitting crystals (LECs).

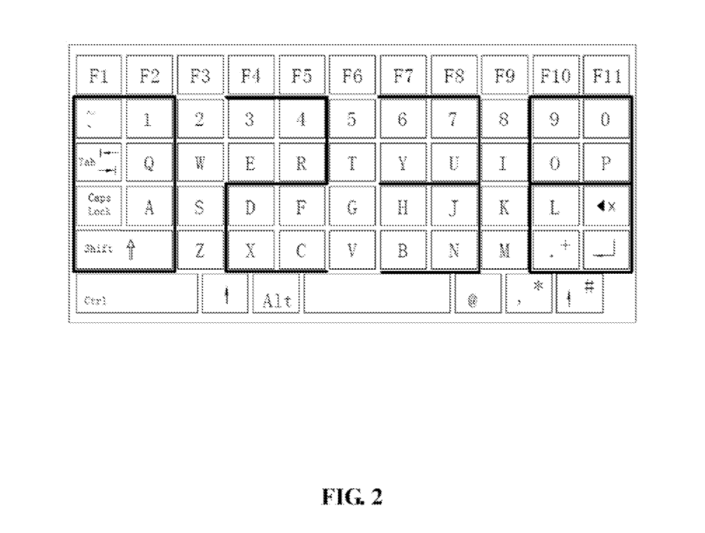

FIG. 2 is a schematic diagram of one embodiment of the keyboard 1 displaying a clock time using the seven segment displays. The seven segment displays can be positioned under several keys of the plurality of keys 10. For example, as shown in FIG. 2, each one of the seven segment displays may be positioned under seven or eight keys of the plurality of keys 10. The material of the plurality of keys 10 here is transparent. The light sources of the seven segment displays can transmit light through the spaces upwardly.

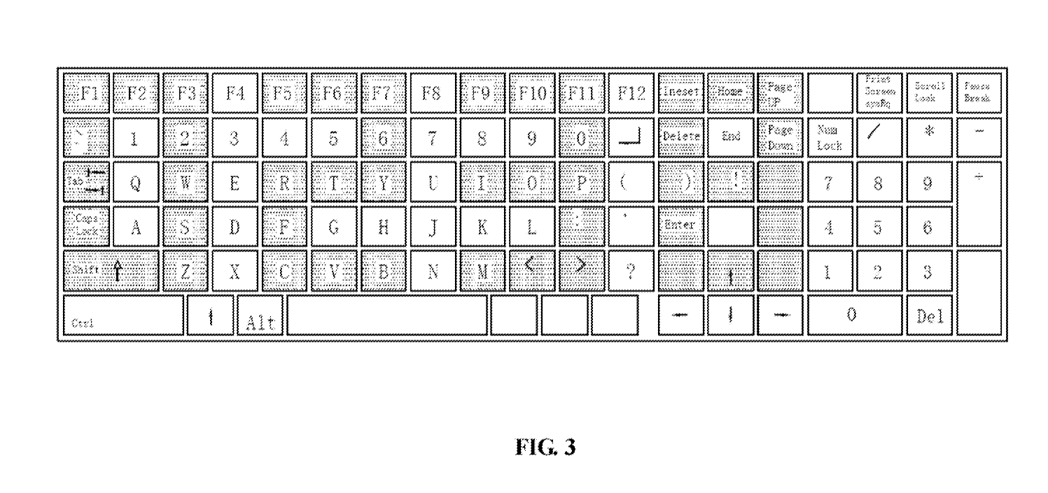

FIG. 3 is a schematic diagram of one embodiment of the keyboard 1 displaying the clock time using dot digital displays. The dot digital displays can be positioned under several keys of the plurality of keys 10. For example, as shown in FIG. 3, each one of the dot digital displays may be positioned under fourteen or fifteen keys of the plurality of keys 10. The material of the plurality of keys 10 here is translucent, whereby the light sources of the dot digital displays can transmit light through the plurality of keys 10 upwardly.

The real time controller 13 is electronically connected to the time display means 12 and the two buttons 131,132 through electronic circuits. The real time controller 13 updates the current time and date to the time display means 12. As shown in FIG. 1, the real time controller 13 is positioned in the keyboard housing 11. For example, the real time controller 13 is positioned near the time display means 12 and the two buttons 131,132.

The two buttons 131,132 are electronically connected to the real time controller 13. The two buttons 131,132 may be installed in any position of the keyboard housing 11. In one embodiment, as shown in FIG. 1, the two buttons 131,132 are installed near the plurality of keys 10. The two buttons 131,132 are used for adjusting the clock time of the real time controller 13. For example, as shown in FIG. 2 and FIG. 3, the clock time of the real time controller 13 can be adjusted from 02:10 to 02:38.

The at least one USB interface 14 is configured in one side of the keyboard housing 11, providing a connection with an external electronic device providing power.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A keyboard, comprising:
a keyboard housing;
a plurality of keys positioned in the keyboard housing positioned between the plurality of keys;
time display means arranged below the plurality of keys and positioned in the keyboard housing; and
a real time controller connected to the time display means through electronic circuits.

2. The keyboard of claim 1, wherein the time display means comprises light sources.

3. The keyboard of claim 2, wherein the light sources are light-emitting diodes.

4. The keyboard of claim 2, wherein the light sources are light emitting crystals.

5. The keyboard of claim 2, wherein the light sources transmit light through material of the plurality of keys.

6. The keyboard of claim 1, wherein the light sources transmit light through the spaces positioned between the plurality of keys.

7. The keyboard of claim 5, wherein the time display means is a dot matrix digital display.

8. The keyboard of claim 6, wherein the time display means is a seven segment digital display.

9. The keyboard of claim 1, wherein the keyboard further comprises two buttons for adjusting a clock time of the keyboard.

10. The keyboard of claim 1, wherein the plurality of keys are made of translucent material.

11. The keyboard of claim 1, wherein the keyboard further comprises at least one USB interface for obtaining power from an external electronic device.
